(19) United States
(12) Patent Application Publication
(10) Pub. No.: US 2010/0230337 A1
(43) Pub. Date: Sep. 16, 2010

(54) WATER TANK APPARATUS

(76) Inventor: Adel Ahmmed Abo-Alnajah Metwally, Jeddah (SA)

Correspondence Address: DRINKER BIDDLE & REATH (DC), 1500 K STREET, N.W., SUITE 1100, WASHINGTON, DC, 20005-1209, US

(21) Appl. No.: 12/521,440

(22) PCT Filed: Nov. 6, 2007
(86) PCT No.: PCT/JP2007/071548

§ 371 Date: Sep. 15, 2009

(51) Int. Cl. B01D 21/02; C02F 1/00; E03B 3/04; E03B 3/06; E03B 3/02

(52) U.S. Cl. 210/170.03

(57) ABSTRACT

A water tank apparatus comprising a first tank (100) for wastewater collection; a second tank (200) for collection of rainwater and groundwater; a third tank (300) connected on the downstream side of the first tank (100) and second tank (200); and a fourth tank (400) disposed at a high position above the ground and connected on the downstream side of the third tank (300) so as to supply any reserved water as a usable water, wherein the first tank (100) and second tank (200) are individually partitioned into first sections (102,202) and second sections (103,203), and wherein the second sections (103,203) are provided with ramps for water flowform its upstream side superior area toward inferior area, the ramps furnished with a multiplicity of projections.

### TECHNICAL FIELD

The present invention relates to a water tank apparatus having the function of purifying water.

### BACKGROUND ART

Recently, there are an increasing number of dry areas in the world that have little rain and encounter water shortages due to global warming etc. In these areas, there can be a war to acquire water, and it is urgently necessary to utilize water without wasting it so that water can be guaranteed for daily life and agriculture.

Conventionally, techniques of converting seawater into freshwater in deserts etc. have been known, but the necessary processes for the techniques require enormously large expenditure, and therefore it is difficult to realize the techniques in poor nations and areas.

On the other hand, there is a known sewage treatment apparatus for mixing liquid sewage such as waste water from kitchens with relatively clean water such as water obtained by sewage treatment (refer to patent document 1).

However, the technique reduces the uncleanness of waste water lower than a predetermined level and release the water, but cannot reuse he treated water.

Furthermore, there is a known apparatus for purifying river water etc. to be used as domestic water after removing humus and phosphorous components from river water etc. (refer to patent document 2).

However, since the apparatus requires an expensive facility such as an electrobath, and a metal compound is added as a flocculant, a high treatment cost is demanded.

### Patent Document 1: Japanese Patent Laid-Open No. 2007-105720

### Patent Document 2: Japanese Patent Laid-Open No. 2005-246238

### Disclosure of the Invention

### Technical Problem

The objective of the present invention is to provide a water tank apparatus for collectively treating various types of water including used and waste water, groundwater, rainwater, etc. into available water for agricultural use, and considerably reducing the equipment cost and running cost without complicated machines or scientific treatment.

### Technical Solution

The water tank apparatus according to the present invention includes: a first tank for collecting waste water; a second tank for collecting rainwater and groundwater; a third tank connected to downstream part of the first tank and the second tank for mixing the water entering from the first and second tanks in; and a fourth tank located at a higher position on a ground above the third tank, connected to a downstream part of the third tank, and supplying stored water as available water. With the configuration, the first and second tanks are sectioned into a first area for receiving water from an upper portion in an upstream part and draining water from an upper portion in a downstream part and a second area for receiving water passing through the first area from the upper portion in the upstream part and draining water from the lower portion in the downstream part to the third tank. The second area has a slope for passing water from the upper portion in the upstream part to the lower portion in the upstream part, and a number of projections are provided on the slope.

The present invention can also have the following configuration.

The third tank is filled with a filter medium.

River water enters the third tank.

The projections are formed by cement chips provided in the most upstream of the slope and each having a number of small voids, and curved projections arranged zigzag in more downstream than the cement chips and forming a curve of concavity toward a higher portion.

A shelf is provided to section the first area of the first tank into upper and lower portions, water entering the first area is temporarily introduced to the lower portion of the shelf, the water is drained to the second area through above the shelf, plural upright walls and suspending walls are alternately arranged on an upper surface of the shelf from the upstream part toward the downstream part, a water path passing above the upright walls and below the suspending walls is formed, plural pass-through holes are formed on the shelf for communicating above and below the shelf, and the pass-through holes can be opened and closed.

A shelf is extended toward a center in the downstream part of the first area of the second tank, water is drained to the second area through above the shelf, a pass-through hole is formed on the shelf for communicating above and below the shelf, and the pass-through hole can be opened and closed.

A side closer to a bottom portion of the second area of the second tank is formed as a water passing side through which groundwater enters, and outside of the water passing side is covered with a filter layer.

The pass-through hole can be closed from below by a floating object.

A maintenance chamber for storing precipitation taken from a bottom portion of the first area is provided for each of the first and second tanks, and the precipitation stored in the maintenance chamber is drained to a treating process.

### Advantageous Effects

According to claim 1 of the invention, various types of water including the waste water from homes etc., rainwater, groundwater, etc. are collectively treated, and a large volume of water available as agricultural water, domestic water, etc.

In addition, since unclean waste water is temporarily separated from less unclean rainwater and groundwater, heavy impurities contained in the water are made to be precipitated out and removed, and light impurities are removed by being caught by the projections, thereby mixing the separated water. in the third tank, the treatment can be performed in the first and second tanks depending on the level of uncleanness.

Furthermore, since the present invention requires no scientific treatment or complicated device, it demands a much lower cost when a large volume of water is treated.

In addition, since available water after the treatment can be stored in the fourth tank provided at a high position above the ground, there is no fear of pollution by a person or a creature, and the amount of the water stored in the fourth tank can be adjusted by controlling the pumping from the third tank.

According to claim 2 of the invention, unclean water can be correctly purified, and can be applied for use at higher purity.

According to claim 3 of the invention, river water can be purified and used.

According to claim 4 of the invention, a pollutant contained in the water that has passed through the first area can be removed after being adsorbed by cement chips, and light impurities can be caught by curved projections and can be efficiently removed.

According to claims 5 and 6, heavy impurities contained in water can be precipitated out while they are passing through above the shelf, and the precipitated impurities can be dropped through pass-through holes and removed.

According to claim 7, the groundwater around the second tank can be purified by a filter layer and used.

According to claim 8, when there is a large amount of precipitation removed from above the shelf, the floating objects drop and release the pass-through holes. Therefore, the precipitation can be automatically dropped with appropriate timing.

According to claim 9, the precipitation containing a large volume of water pumped from the first areas of the first and second tanks is temporarily stored in a maintenance chamber, the water content is reduced, and then packed and transferred, thereby easily treating the precipitation.

### Best Mode for Carrying Out the Invention

The embodiments of the present invention are described below with reference to the attached drawings.

As shown in FIG. 1, the water tank apparatus according to the present invention includes a first tank 100 for collecting waste water such as domestic water drained from homes, schools, public facilities, etc., a second tank 200 for collecting rainwater and groundwater, a third tank 300 connected to the downstream parts of the first tank 100 and the second tank 200 and mixing the water entering from the first tank 100 and the second tank 200 in, and a fourth tank 400 connected to the downstream part of the third tank 300 and supplying the water stored inside as available water.

The first tank 100 has a concrete housing sealed so that waste water can not be spilled out and cannot pollute the ambient area, and sectioned by a partition 101 as shown in FIGS. 2 and 3 into a first area 102 receiving water from the upper portion in an upstream part and draining water from the upper portion in a downstream part, and a second area 103 receiving the water that has passed through the first area 102 from the upper portion in an upstream part and draining water from the lower portion in a downstream part to the third tank 300.

The first area 102 is sectioned into upper and lower portions by a shelf 104 provided at a portion closer to the upper portion, and the waste water entering the first tank 100 is introduced to the lower portion of the shelf 104 through an aqueduct 105 passing through the shelf 104.

A deep channel portion 106 is formed at a portion closer to the upstream of the shelf 104, and a branch point 107 is formed open to the lower portion of the shelf 104 on the side of the channel portion 106. Therefore, the water introduced to the lower portion of the shelf 104 enters the upper portion the shelf 104 through the branch point 107 and the channel portion 106 when the amount of water increases.

Furthermore, the shelf 104 is gradually inclined to be lower toward the downstream part from the channel portion 106. Above the inclined portion, a plurality of upright walls 108 and suspending walls 109 are alternately arranged from the upstream part to the downstream part as shown in FIG. 4, and a water path is formed to pass through above the upright wall 108 and below the suspending wall 109.

At the end of the top surface of the shelf 104, a drain hole 110 is formed in the partition 101 so that the water passing through the water path above the shelf 104 enters the second area 103 through the drain hole 110.

A plurality of pass-through holes 111 that can be opened and closed are formed at the bottom of the channel portion 106 and the shelf 104. As shown in FIGS. 9 and 7, the upper portion of the pass-through holes 111 is a tapered hole having a larger diameter at the top end so that the precipitation can be collected at the lower portion of the pass-through holes 111.

Furthermore, floating objects 112 attachably and detachably engaged in the aperture at the bottom surface are connected to the lower end of the pass-through holes 111. When the first area 102 is vacant or contains only a small amount of water, the floating objects 112 are suspended at the lower portion and the pass-through holes 111 are open (FIG. 6). However, when water is filled in the lower portion of the shelf 104, the floating objects 112 pushed up by the water pressure are engaged in the pass-through holes 111, and the pass-through holes 111 are closed from below (FIG. 7).

The second area 103 is provided with a slope 113 for passing water from the drain hole 110 formed at the upper portion in an upstream part to the lower portion with loopback repetitions as shown in FIGS. 2 and 3. The slope 113 at the most upstream is prepared in an upward expanded form in which the slope once rises and gradually descends from the drain hole 110 toward the downstream.

The peak of the upward expanded form is higher than the upper end of the drain hole 110, and is substantially as high as the upper end of the upright wall 108 so that a large volume of water cannot simultaneously flow down the slope 113.

A large number of projections 114 are provided on the top surface of the slope 113. The projections 114 are formed by cement chips 115 having a large number of voids provided at the most upstream of the slope 113, and curved projections 116 provided at the downstream part of the cement chips 115.

The curved projections 116 are formed by cement materials that are less expensive and can be easily repaired and replaced, and form a concavity toward the upstream part as shown in FIG. 5. In addition, the curved projections 116 are arranged zigzag not to linearly pass water among them.

Furthermore, as shown in FIGS. 3 and 1, a pipe 117 is connected and extended from the bottom portion of the second area 103 and connected to the second area 103. When a pump 121 provided in the pipe 117 is driven, the water stored at the bottom portion of the second area 103 is transmitted to the third tank 300 through the pipe 117.

Furthermore, an aperture 118 for maintenance and inspection is formed at the top plate of the first tank 100, and the aperture 118 is covered with a lid.

The second tank 200 has a concrete housing, and is buried at least lm underground. The second tank 200 is appropriately located in a place where rainwater can be easily gathered and the underground water level is relatively high.

As shown in FIGS. 8 and 9, the second tank 200 is sectioned by a partition 201 into a first area 202 for receiving water from the upper portion in an upstream part through an aqueduct 205 and draining water from the upper portion in a downstream part, and a second area 203 for receiving water that has passed the first area 202 from the upper portion in an upstream part, and draining water from the lower portion in a downstream part to the third tank 300.

The first area 202 receives collected rainwater, groundwater from underground water route, etc. through an aqueduct 205.

A shelf 204 is extended from the center in a downstream part in a position closer to the upper portion of the first area 202, and a channel portion 206 and a branch point 207 similar to the equivalent portions in the first tank 100 are formed in the place closer to the shelf 204.

The shelf 204 is inclined to gradually ascend from the channel portion 206 to the downstream part, and a drain hole 210 is formed in the partition 201 at the end of the top surface of the shelf 204.

Like in the first tank 100, a pass-through holes 211 is formed at the bottom of the channel portion 206, and the pass-through holes 211 can be closed from below by floating objects 212.

Since the water entering the second tank 200 is less unclean than the waste water collected in the first tank 100, a complicated water path including an upright wall and a suspending wall is not formed above the shelf 204.

At the end of the top surface of the shelf 204, the drain hole 210 is formed in the partition 201, and the water passes from the first area 202 to the second area 203 through the drain hole 210.

The second area 203 is provided with a slope 213 similar to the slope 113 of the first tank 100 from the drain hole 210 to the position closer to the bottom portion, and projections 214 formed by the cement chips 215 and the curved projections 216 similar to the cement chips 115 and the curved projections 116 are provided on the top surface of the slope 213.

The bottom of the second area 203 is deeper than the lower end of the slope 213 and the bottom of the first area 202, and the side closer to the bottom of the second area 203 is a water passing side 219 covered with a metal net.

The outside of the water passing side 219 is covered with a filter layer 220, and the groundwater enters the bottom portion of the second area 203 through the filter layer 220 and the water passing side 219.

A pipe 217 extended to the outside is connected to the bottom portion of the second area 203, and water is fed from the bottom portion of the second area 203 toward the third tank 300 when a filter layer 220 is driven.

Furthermore, an aperture 218 for maintenance and inspection is formed at the top plate of the second tank 200, and the aperture 218 is covered with a lid.

The third tank 300 has a housing of a concrete material, and the top surface can be closed or opened. As shown in FIG. 10, when the top surface of the third tank 300 is closed, an aperture 318 for maintenance and inspection is formed on the top plate.

In the present embodiment, the third tank 300 is buried in the ground such that the top surface can be exposed on the ground, and the outside of the third tank 300 is covered with a protective layer 322 of a wire fence etc. for protection.

As shown in FIG. 1, the pipe 117 extended from the first tank 100 and the pipe 217 extended from the second tank 200 are connected to one side of the third tank 300, and a pumping pipe 317 is connected to the other side of the third tank 300.

The pumping pipe 317 is extended to the fourth tank 400, and when a pump 321 provided for the pumping pipe 317 is driven, the water in the third tank 300 is pumped to the fourth tank 400.

The third tank 300 can be provided near a river to take in the river water to the third tank 300. In this case, the third tank 300 is filled with the filter medium such as sand etc. to remove impurities contained in the river water.

The fourth tank 400 is supported by a base 401, and is mounted above in a position higher than the third tank 300.

A feed pipe 402 is extended from the fourth tank 400, and the water stored in the fourth tank 400 is fed as available water through the feed pipe 402.

Since the fourth tank 400 is mounted in a high position on the ground, there is no fear of pollution by a person or a creature during storage.

The water tank apparatus treats and feeds water as follows.

Waste water drained from homes etc. is collected and introduced to the first area 102 of the first tank 100 through an aqueduct. The waste water once passes to the lower portion of the shelf 104, and then passes to the upper portion of the shelf 104 through the channel portion 106 when the space enclosed by the shelf 104 is filled.

In this status, the floating objects 112 is pushed up by water pressure, and the pass-through holes 111 is closed.

In a space in the lower portion of the shelf 104, heavy impurities mixed in water are precipitated at the bottom of the first area 102 and light impurities float. The water flowing toward the upper portion of the shelf 104 passes through the water path formed between the upright wall 108 and the suspending wall 109, and reaches the second area 103 through the drain hole 110.

Heavy impurities are precipitated while passing through above the shelf 104, and stored at the bottom of the pass-through holes 111 blocked by the floating objects 112. If the water at the lower portion of the shelf 104 decreases or a large amount of precipitation is stored, then the floating objects 112 drop and the pass-through holes 111 is opened, and the stored precipitation drops and is precipitated on the bottom of the first area 102. During the process, the light impurities contained in the water are caught by the upright wall 108 and the suspending wall 109.

The water that has reached the second area 103 flows on the top surface of the slope 113, and reaches the bottom of the second area 103. While passing through the slope 113, the light impurities contained in the water are caught by the projections 114 and removed. In addition, the impure objects in the water are adsorbed while transmitting through the cement chips 115.

When a predetermined period passes, a lot of precipitation are piled on the bottom of the first tank 100, and the volume of the light impurities caught by the upright wall 108, the suspending wall 109, and the projections 114 increases, the flow of the water to the first tank 100 is stopped, the aperture 118 is opened, and a maintaining process is performed. The precipitation piled on the bottom of the first tank 100 is pumped with the water, and the impurities caught by the upright wall 108, the suspending wall 109, and the projections 114 are swept.

The water that has entered the first area 202 of the second tank 200 through the aqueduct 205 reaches the upper portion of the shelf 204 through the channel portion, passes through the top surface of the shelf 204 and the drain hole 210, and reaches the second area 203.

The water that has entered the second area 203 reaches bottom of the second area 203 through the slope 213. In the meantime, like the first tank 100, heavy impurities and light impurities are removed from the water in the second tank 200.

The groundwater near the second tank 200 enters the bottom portion of the second area 203 from the water passing side 2019 after passing through the filter layer 220.

The water stored in the second area 103 of the first tank 100 and the water stored in the second area 203 of the second tank 200 are transmitted to the third tank 300 through the pipes 117 and 217 respectively, mixed in the third tank 300, and pumped to the fourth tank 400 through the pumping pipe 317.

When the third tank 300 is filled with a filter medium, the passing water is further purified in the third tank 300.

Furthermore, when river water is taken to the third tank 300, the river water is also mixed with the water that has passed through the first tank 100 and the water that has passed through the second tank 200, and is filtered by the filter medium in the third tank 300.

The water transmitted to the fourth tank 400 and stored therein is fed as available water through the feed pipe 402.

The water tank apparatus according to the present invention can feed water to a large area such as an airport, a city, a university, etc., to a number of isolated living units, and also to a single unit. Therefore, the sizes of the first tank 100, the second tank 200, the third tank 300, and the fourth tank 400 can be appropriately changed depending on the amount of water to be treated.

When the first tank 100, the second tank 200, the third tank 300, and the fourth tank 400 are large, inspection and maintenance staffs can enter the tanks for the respective operations. However, when they are small, the removed impurities are taken out of the tanks by a take-up device and then treated.

When a large volume of water is treated, the amount of precipitation piled at the bottom portions of the first tank 100 and the second tank 200 is also large. Therefore, each of the first tank 100 and the second tank 200 is provided with a maintenance chamber for storing the precipitation pumped from the bottom portion of the first areas 102 and 202 respectively.

Since the precipitation containing a large amount of water is heave and bulky, the water content is reduced by temporarily storing it in the maintenance chamber. When it is half dried, it is carried out for a treating step by a convey device such as a conveyor etc. or a carry car, and then packed.

An aperture unit is provided for maintenance and inspection in the maintenance chamber.

### BRIEF DESCRIPTION OF THE DRAWINGS

FIG. 1 is a perspective view of the water tank apparatus according to an embodiment of the present invention;

FIG. 2 is a perspective view of the first tank;

FIG. 3 is a sectional view of the first tank;

FIG. 4 is a sectional view of the important portion of the first tank;

FIG. 5 is an enlarged plan view of the important portion of the slope;

FIG. 6 is a sectional view of the important portion of the shelf when the pass-through holes are open;

FIG. 7 is a sectional view of the important portion of the shelf when the pass-through holes are closed;

FIG. 8 is a perspective view of the second tank;

FIG. 9 is a sectional view of the second tank; and

FIG. 10 is a sectional view of the third tank.

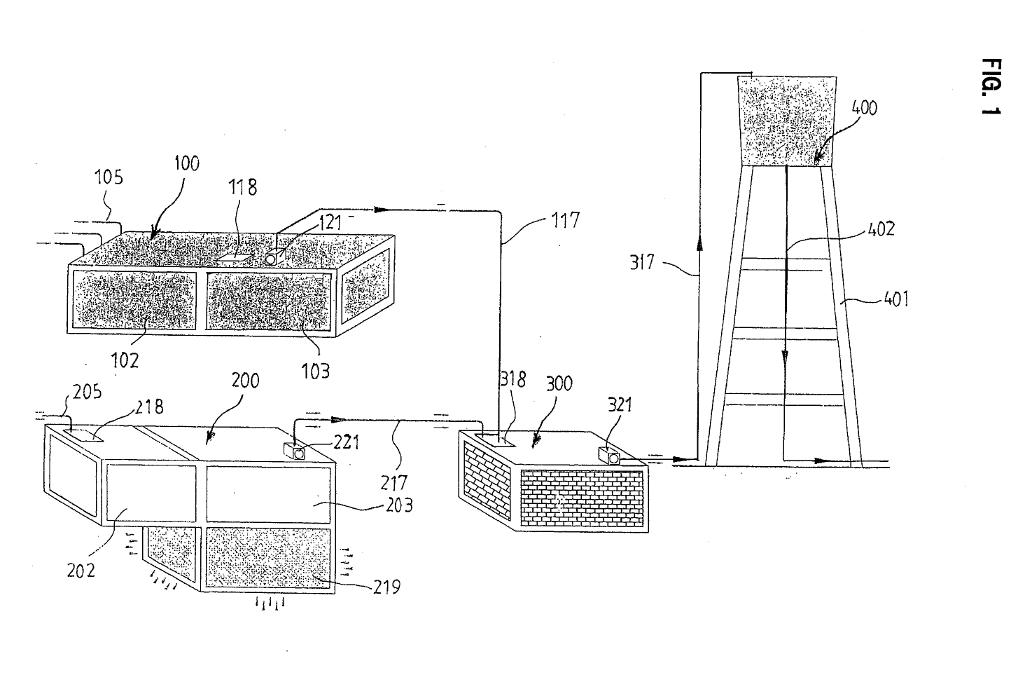

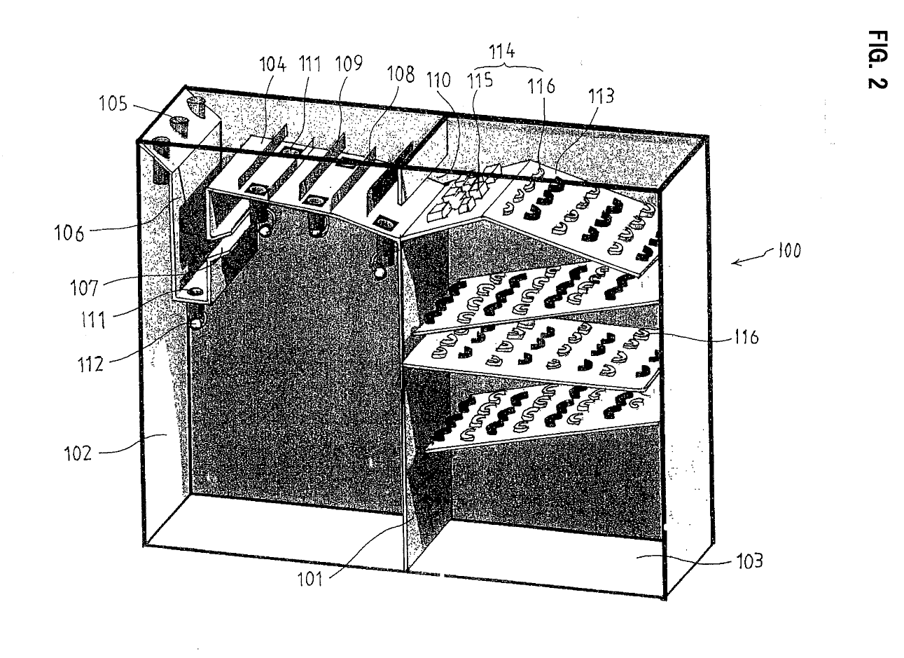

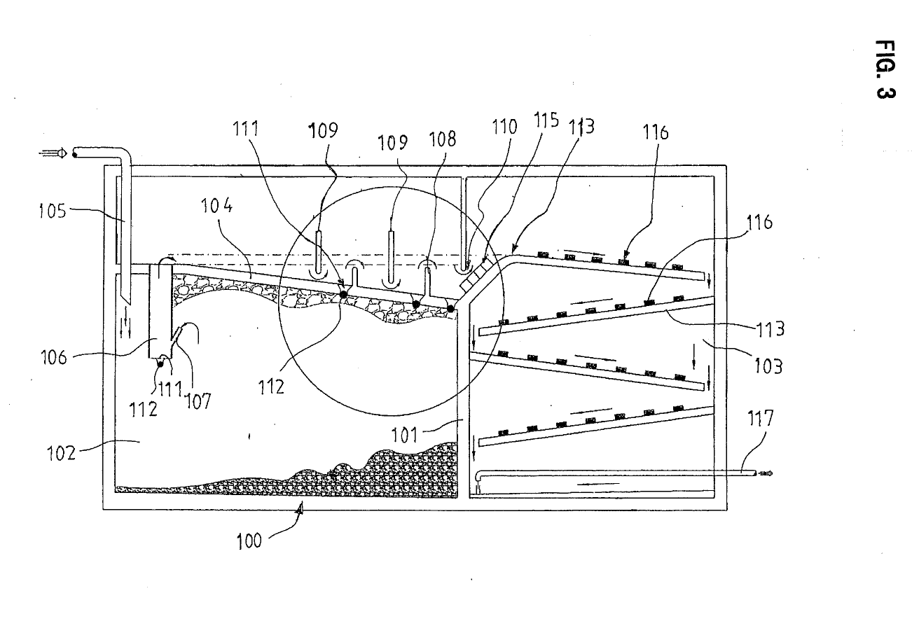

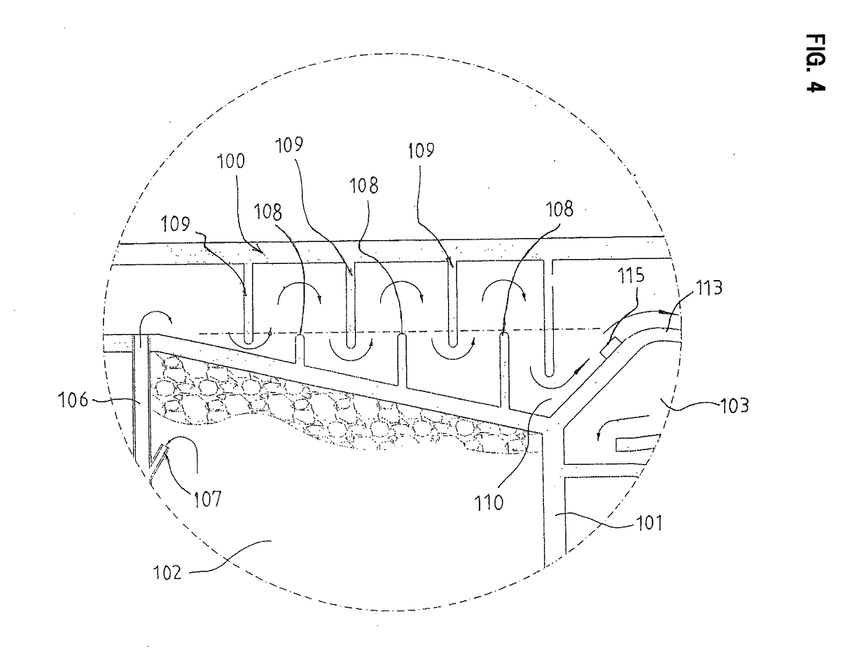

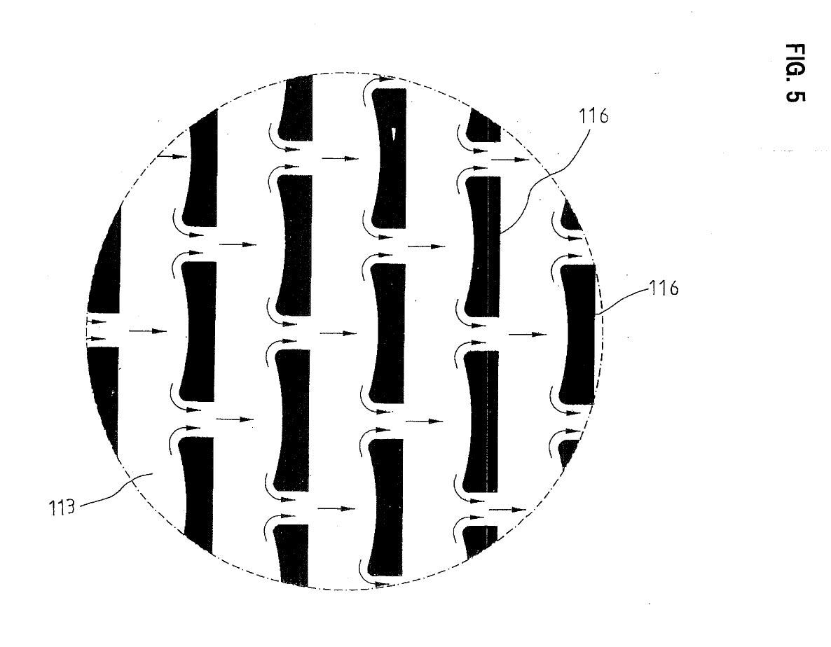

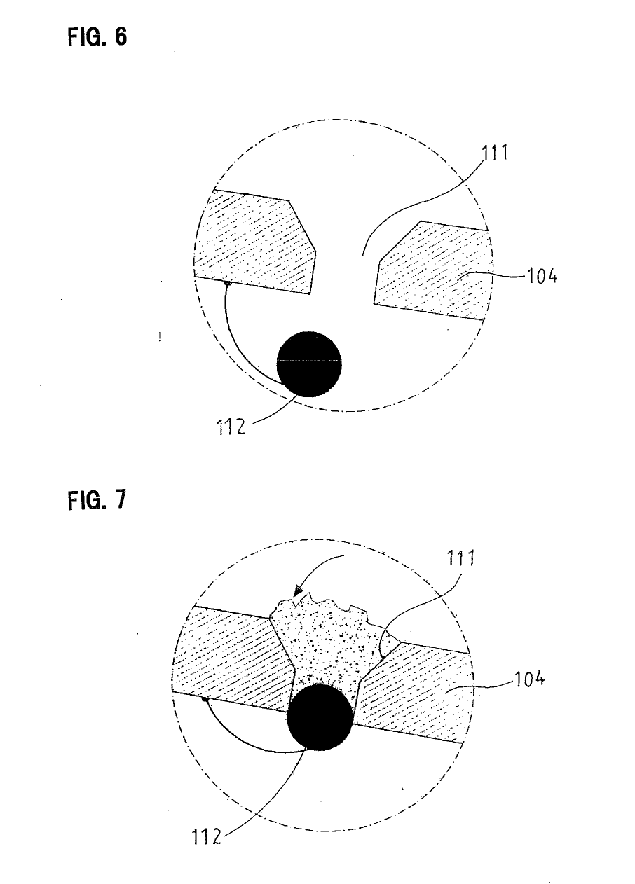

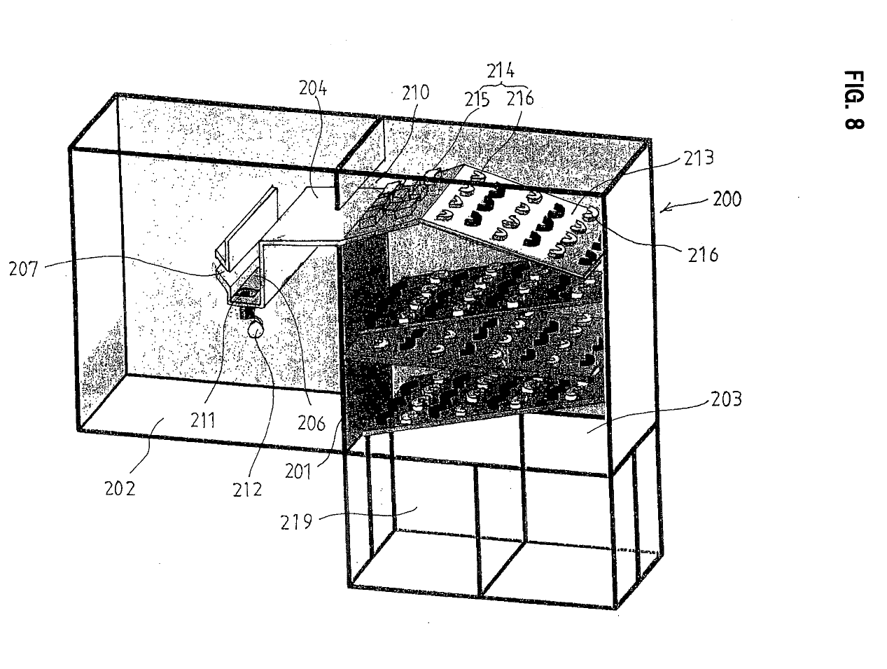

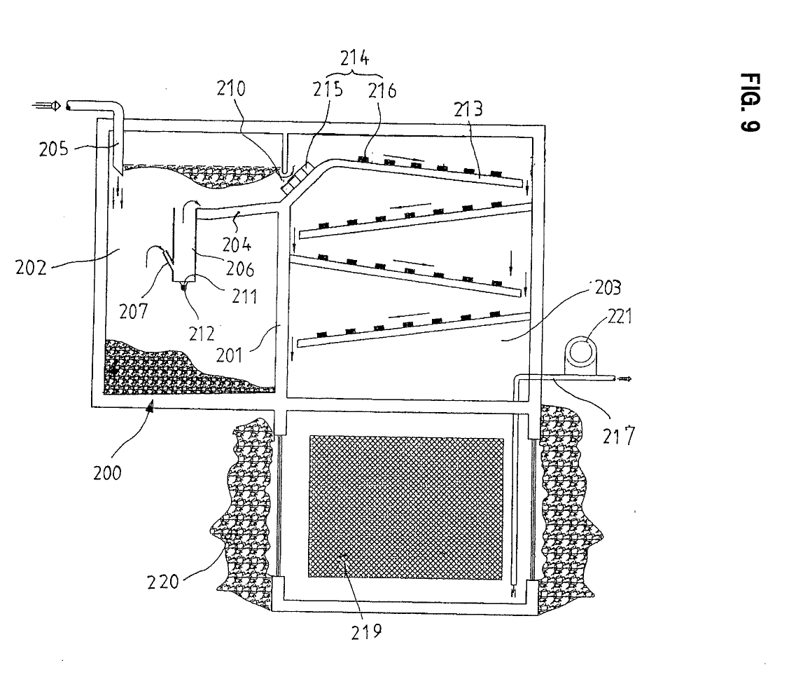

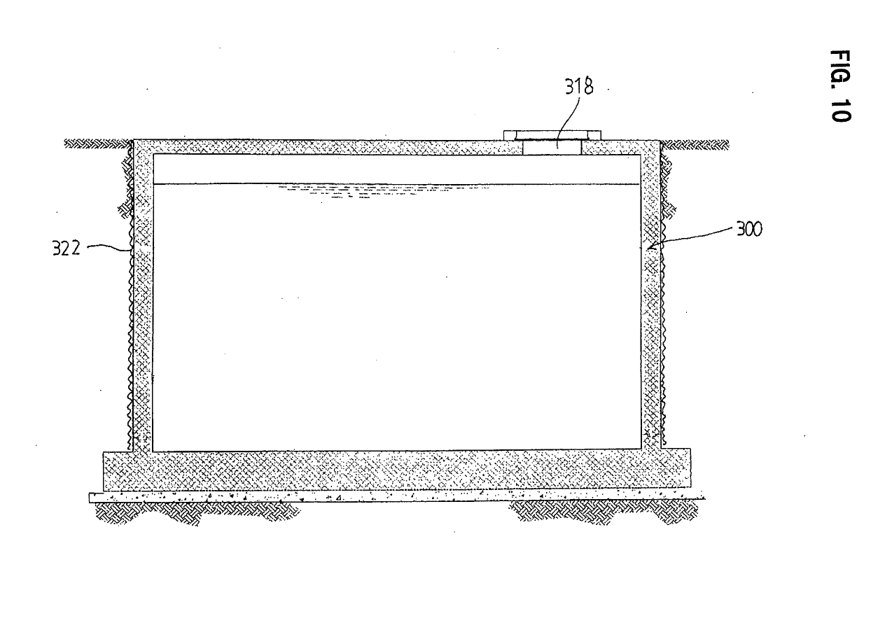

### Description of Symbols

100 first tank
101 partition
102 first area
103 second area
104 shelf
105 aqueduct
106 channel portion
107 branch point
108 upright wall
109 suspending wall
110 drain hole
111 pass-through holes
112 floating objects
113 slope
114 projections
115 cement chips
116 curved projections
117 pipe
118 aperture
121 pump
130 maintenance chamber
200 second tank
201 partition
202 first area
203 second area
204 shelf
205 aqueduct
206 channel portion
207 branch point
210 drain hole
211 pass-through holes
212 floating objects
213 slope
214 projections
215 cement chips
216 curved projections
217 pipe
218 aperture
219 water passing side
220 filter layer
221 pump
300 third tank
317 pumping pipe
318 aperture
321 pump
322 protective layer
400 fourth tank
401 base
402 feed pipe

1. A water tank apparatus, comprising:
a first tank for collecting waste water;
a second tank for collecting rainwater and groundwater;
a third tank connected to downstream parts of the first tank and the second tank for mixing the water entering from the first and second tanks in; and
a fourth tank located at a higher position on a ground above the third tank, connected to a downstream part of the third tank, and supplying stored water as available water, wherein:
the first and second tanks are sectioned into a first area for receiving water from an upper portion in an upstream part and draining water from an upper portion in a downstream part and a second area for receiving water passing through the first area from the upper portion in the upstream part and draining water from the lower portion in the downstream part to the third tank; and
the second area has a slope for passing water from the upper portion in the upstream part to the lower portion in the upstream part, and a number of projections are provided on the slope.

2. The water tank apparatus according to claim 1, wherein the third tank is filled with a filter medium.

3. The water tank apparatus according to claim 2, wherein river water enters the third tank.

4. The water tank apparatus according to claim 1, wherein
the projections are formed by cement chips provided in the most upstream of the slope and each having a number of small voids, and curved projections arranged zigzag in more downstream than the cement chip and forming a curve of concavity toward a higher portion.

5. The water tank apparatus according to claim 1, wherein
a shelf is provided to section the first area of the first tank into upper and lower portions, water entering the first area is temporarily introduced to the lower portion of the shelf, the water is drained to the second area through above the shelf, plural upright walls and suspending walls are alternately arranged on an upper surface of the shelf from the upstream part toward the downstream part, a water path passing above the upright walls and below the suspending walls is formed, plural pass-through holes are formed on the shelf for communicating above and below the shelf, and the pass-through holes can be opened and closed.

6. The water tank apparatus according to claim 1, wherein
a shelf is extended toward a center in the downstream part of the first area of the second tank, water is drained to the second area through above the shelf, a pass-through hole is formed on the shelf for communicating above and below the shelf, and the pass-through hole can be opened and closed.

7. The water tank apparatus according to claim 6, wherein a side closer to a bottom portion of the second area of the second tank is formed as a water passing side through which ground water enters, and outside of the water passing side is covered with a filter layer.

8. The water tank apparatus according to claim 5, wherein
the pass-through hole can be closed from below by a floating object.

9. The water tank apparatus according to claim 1, wherein
a maintenance chamber for storing precipitation taken from a bottom portion of the first area is provided for each of the first and second tanks, and the precipitation stored in the maintenance chamber is drained to a processing process.
